(19) United States
(12) Patent Application Publication
(10) Pub. No.: US 2026/0062963 A1
(43) Pub. Date: Mar. 5, 2026

(54) ANTI-THEFT DEVICE FOR A PERSONAL CARE ITEM

(71) Applicant: THE PROCTER & GAMBLE COMPANY, Cincinnati, OH (US)

(72) Inventors: Sven MUELLER, Schmitten (DE); Aljoscha ROSEMANN, Offenbach (DE); Corinna ROTH, Frankfurt (DE); Martin WENZLAWIAK, Frankfurt (DE)

(21) Appl. No.: 19/302,385

(22) Filed: Aug. 18, 2025

(30) Foreign Application Priority Data
Aug. 30, 2024 (EP) 24197594.5

(51) Int. Cl. E05B 73/00

(52) U.S. Cl. CPC E05B 73/0011

(57) ABSTRACT

An anti-theft device 12 for a personal care item 14 comprises an elastomeric pad 16 attachable to the personal care item 14, a security cord 18 and a mounting tool 20 for mounting the anti-theft device 12 to a wall or other fixed object. The security cord 18 has a first end 22 and a second end 24, the first end 22 being attachable to the elastomeric pad 16, and the second end 24 being attached to the mounting tool 20. A kit 10 comprises such anti-theft device 12 and a personal care item 14.

### FIELD OF THE INVENTION

The present disclosure is concerned with an anti-theft device for a personal care item, the anti-theft device being attachable to the personal care item. The present disclosure is further concerned with a kit comprising such anti-theft device and a personal care item.

### BACKGROUND OF THE INVENTION

In today's retail environment, personal care items, particularly those of relatively high value such as electrical toothbrushes or shavers and razors, are often subject to theft or unauthorized removal. Retail establishments face ongoing challenges in protecting these valuable items from unauthorized removal or shoplifting.

Retail establishments have implemented various anti-theft measures to mitigate these risks. Conventional anti-theft devices often include mechanical fastening mechanisms, electronic alarm systems, or physical barriers. However, these prior art solutions suffer from several disadvantages that limit their effectiveness and usability.

One common anti-theft approach involves the use of mechanical fastening mechanisms, such as locking brackets or clamps, to secure personal care items to store shelves or displays. While these mechanisms provide a certain level of deterrence, they can be cumbersome to use for both store employees and customers. Furthermore, the reliance on keys or specialized locking tools creates logistical challenges.

Another approach is the implementation of electronic alarm systems that trigger an audible or visual alert when a personal care item is tampered with or removed without proper authorization. While these systems can discourage theft, they often result in false alarms, inconveniencing both customers and store personnel. Additionally, the installation and maintenance of such systems can be costly and require specialized expertise.

Physical barriers, such as locked display cases or transparent enclosures, are also employed to protect personal care items. While these barriers offer a higher level of security, they can create a barrier between the product and the customer, hindering the ability to interact with or evaluate the item before making a purchase decision. This lack of accessibility and customer engagement may result in reduced sales and customer satisfaction.

Furthermore, many existing anti-theft devices are designed with limited compatibility, rendering them suitable for only specific models or sizes of personal care items. This lack of versatility limits their applicability in diverse retail environments and necessitates the use of multiple anti-theft solutions, increasing complexity and costs for retailers.

Summarizing, existing anti-theft solutions often lack effectiveness, ease of use, or compatibility with a wide range of personal care items.

It is an object of the present disclosure to provide an anti-theft device for a personal care item which overcomes at least one of the above-mentioned drawbacks, in particular which combines effective security measures with ease of use and broad compatibility.

### SUMMARY OF THE INVENTION

In accordance with one aspect, an anti-theft device for a personal care item is provided, the anti-theft device comprising an elastomeric pad attachable to the personal care item, a security cord and a mounting tool for mounting the anti-theft device to a wall or other fixed object, the security cord having a first end and a second end, the first end being attachable to the elastomeric pad, and the second end being attached to the mounting tool.

In accordance with one aspect a kit is provided, the kit comprising such anti-theft device and a personal care item.

### BRIEF DESCRIPTION OF THE DRAWINGS

The invention is described in more detail below with reference to various embodiments and figures, wherein:

FIG. 1 shows an example embodiment of a kit comprising a personal care item, and an anti-theft device according to the present disclosure, the anti-theft device being attached to the personal care item;

FIG. 2 shows a perspective view of an elastomeric pad of the anti-theft device of FIG. 1, with a security cord attached thereto;

FIG. 3 shows a back view of the elastomeric pad of FIG. 2, and

FIG. 4 shows a back view of the elastomeric pad of FIG. 2 with the security cord attached.

### DETAILED DESCRIPTION OF THE INVENTION

An anti-theft device for a personal care item according to the present disclosure comprises an elastomeric pad attachable to the personal care item, a security cord, and a mounting tool for mounting the anti-theft device to a wall, display, shelf or the like. The security cord connects the elastomeric pad with the mounting tool in a tamper-proof manner. The anti-theft device is designed to protect the personal care item from theft or unauthorized removal, and is adaptable and compatible with various personal care items of value that are typically found in retail stores. The device's design allows for versatility, accommodating different shapes, sizes, and attachment points on the respective personal care items. For example, the personal care item may be an electrical or a manual toothbrush, a shaver or razor, a hair trimmer, epilator, electric facial cleansing brush, an electrical massager, a nail care device, a jar, like a cream jar, a medical product, or the like.

The elastomeric pad serves as the attachment point for the anti-theft device on the personal care item. It is made from an elastomeric material that offers flexibility, durability, and resistance to tampering. The pad is securely attachable to the personal care item, ensuring a tight fit without causing damage or impeding the item's functionality.

The elastomeric material of the pad allows for flexibility and ability to conform to different shapes, in particular those with elongated shapes. The elastomeric pad possesses inherent elasticity and pliability, allowing it to easily adapt to the structure and contours of different personal care items. It can conform to various shapes, sizes, and textures, ensuring a secure and tight fit. This adaptability is particularly beneficial for personal care items that have elongated shapes, such as electrical toothbrushes, shavers, or razors. In other words, the flexibility of the elastomeric pad enables it to wrap around and conform to the handle or other suitable attachment points on the personal care item. The elastomeric pad can deform and stretch within certain limits. This allows it to accommodate variations in the dimensions and shapes of different personal care items. Whether the item has a slender or thicker handle, a curved or straight design, the elastomeric pad can conform to the specific structure, providing a reliable and secure attachment point.

The suitability of the elastomeric pad for use with different products is an advantage of the anti-theft device. Its flexibility, adaptability, and ability to conform to a wide range of shapes make it versatile and compatible with various personal care items. This allows the anti-theft device to be used across different product lines, providing retailers with a single solution for securing multiple personal care items, reducing complexity and costs.

The elastomeric pad may be attached to the personal care item by means of glue or adhesive material to create a bond between the elastomeric pad and the surface of the personal care item to be secured. The glue or adhesive selected is preferably compatible with both, the elastomeric material of the pad and the surface material of the personal care item where the pad shall be attached.

The back side of the elastomeric pad may comprise gluing spots for gluing the elastomeric pad to the personal care item. Such gluing spots provide designated areas on the back side of the elastomeric pad where adhesive/glue can be applied. The spots provide clear guidance for the application of adhesive/glue, eliminating the need for precise application or guesswork. This feature enhances the user-friendliness of the anti-theft device and allows for efficient and convenient attachment.

The back side of the elastomeric pad may comprise an outer rim for retaining glue at the back side of the elastomeric pad. Such outer rim is to create a boundary or barrier that helps retain glue/adhesive material at the back side of the pad, e.g. during the attachment process. The rim may help containing the glue within its boundaries, preventing excessive spreading or overflow on visible surfaces. The adhesive/glue remains concentrated in the desired attachment region, thereby enhancing the strength and reliability of the bond, ensuring a secure attachment as well as a clean and tidy appearance.

The glue/adhesive material may be selected from the following list: Cyanoacrylates, polyurethane adhesives, and epoxy resins.

Attaching the elastomeric pad to the personal care item by gluing may comprise the following steps:
Surface preparation to ensure that both, the surface of the personal care item and the contact surface of the elastomeric pad are clean and free from dirt, dust, oils or the like, to promote improved adhesion.
Adhesive application by applying an appropriate adhesive to either the surface of the personal care item or the contact surface of the elastomeric pad.
Bonding by positioning the elastomeric pad onto the desired location on the personal care item, thereby ensuring proper alignment and contact, optionally applying appropriate pressure to create a strong bond between the pad and the item.
Curing the adhesive, optionally by maintaining pressure on the bonded surfaces for a specific period of time.

By gluing the elastomeric pad to the personal care item, a secure attachment can be provided. The adhesive can create a strong bond between the pad and the item, ensuring that the anti-theft device remains securely in place during usage of the item.

In addition, or alternatively, the elastomeric pad can be attached to the personal care item by an adhesive strip or tape. Such strips may have adhesive properties on both sides and can be pre-cut to the desired shape and size. One side of the strip adheres to the elastomeric pad, while the other side attaches to the surface of the personal care item. Adhesive strips or tapes may provide a convenient attachment method without leaving residue or causing damage to the item.

The mounting tool of the anti-theft device is a component that allows the anti-theft device to be affixed to a fixed object, such as a wall, shelf, or display. It provides a secure point of attachment for the security cord, ensuring that the personal care item is tethered to the designated location.

The mounting tool can be a compact and lightweight component made of durable materials, such as plastic. Alternatively, the mounting tool may be made from metal. The mounting tool may have a flat or contoured back surface with multiple attachment points or features to facilitate its secure fixation to various surfaces, including walls, display stands, shelfs etc.

To fix the mounting tool to a wall, shelf, display, or similar surfaces, various methods can be employed. One example is the use of adhesive materials, such as adhesive tapes or (industrial-grade) adhesives/glues. The mounting tool may have a flat back surface with adhesive backing, allowing it to be firmly adhered to the desired surface. Alternatively, the mounting tool may feature pre-drilled holes or slots to accommodate screws, nails, or other fasteners for more permanent installations. In the case of gluing, a suitable adhesive, such as epoxy or industrial-strength glue, can be applied to the back surface of the mounting tool. The tool is then pressed firmly against the desired surface and held in place until the adhesive cures or sets, creating a strong and secure bond.

The elastomeric pad is secured at the mounting tool via a security cord. The security cord can be a flexible cord or cable that provides a secure connection between the personal care item/elastomeric pad and the mounting tool. For example, the security card can be made from stainless steel or aramid fiber (e.g. Kevlar). The cord has a first end and a second end. The first end is attachable to the elastomeric pad, enabling a secure connection between the pad and the cord. The attachment ensures that the personal care item remains linked to the anti-theft device. The second end of the security cord is attached to the mounting tool.

To securely attach the security cord to the mounting tool, the mounting tool may incorporate an attachment mechanism for the cord. This mechanism can include a groove, slot, or channel where the security cord is threaded or inserted, ensuring a reliable connection. The attachment mechanism may further include a locking or clamping mechanism that securely holds the security cord in place, preventing disconnection by a user exploring and testing the personal care item.

The mounting tool may comprise a retraction mechanism allowing the security cord to be extended and automatically retracted when released.

Such retraction mechanism enables the security cord to be extended when needed and automatically retracted back into the mounting tool when released, providing convenience and ensuring the cord remains securely stored. By this retraction mechanism functionality and usability of the anti-theft device is further enhanced. It allows the security cord to be easily extended for handling, examining, or using the personal care item while keeping it tethered to the mounting tool and preventing unauthorized removal. When the user pulls on the security cord to extend it, the retraction mechanism, e.g. spring-loaded, allows the cord to be pulled out from the mounting tool. The cord extends to a desired length, providing sufficient flexibility for comfortable use or examination of the personal care item.

Upon releasing the cord, the e.g. spring-loaded mechanism retracts the cord back into the mounting tool automatically. This automatic retraction eliminates the need for manual winding or management of excess cord length, ensuring a neat arrangement. The cord is safely stored within the mounting tool, reducing the risk of tangling.

The retraction mechanism can include additional features for user control and customization. For example, a locking mechanism may be incorporated to hold the cord in an extended position until intentionally released by the user. This feature allows the user to maintain the cord at a desired length for extended periods, facilitating ease of use without constant tension on the cord.

The retraction mechanism enhances the overall functionality and convenience of the anti-theft device. It ensures that the security cord is easily accessible when needed and efficiently retracts when not in use, providing a tidy and secure storage solution. This feature contributes to the user-friendly nature of the device.

The elastomeric pad may be made from a thermoplastic elastomeric material (TPE e.g. TPA, TPC, TPO, TPS, TPV), ethylene-vinyl acetate (EVA), NBR, from thermoplastic materials, e.g. polypropylene (PP), from silicone rubber and/or natural rubber. Thermoplastic elastomers (TPEs) offer excellent elasticity, flexibility, and resilience, making them suitable for the elastomeric pad of the anti-theft device. Such materials are able stretch to some extent and deform under force, allowing the pad to adapt to the shape and contours of various personal care items. TPEs also provide good grip and friction, ensuring a secure attachment without slippage. Additionally, TPEs can be easily molded or formed, allowing for efficient and cost-effective production of the elastomeric pad.

Silicone Rubber as another suitable material for the elastomeric pad also offers flexibility, durability, and excellent elongation and recovery properties, allowing the elastomeric pad to stretch and conform to different shapes and sizes of personal care items. Silicone rubber provides a soft and comfortable grip, ensuring a secure hold on the item. Its non-reactive nature makes it suitable for use with various personal care products, including those with sensitive materials. Silicone rubber is also resistant to moisture, chemicals, and UV radiation, ensuring long-lasting performance of the anti-theft device.

Natural rubber as another suitable material for the elastomeric pad, is a traditional elastomeric material known for its high elasticity and resilience. It offers excellent stretching capability, allowing the elastomeric pad to adapt to different shapes and sizes of personal care items. Natural rubber provides good grip and friction, ensuring a secure attachment that minimizes slippage. Its natural texture makes it comfortable to hold and handle.

These elastomeric materials, whether thermoplastic elastomers, silicone rubber, or natural rubber, offer the necessary properties of flexibility, adaptability, and grip to facilitate the secure and adaptable attachment of the anti-theft device to different personal care items. Their specific characteristics contribute to the functionality and effectiveness of the elastomeric pad in providing a reliable and secure hold on the items, while also ensuring ease of use and comfort for the user.

The elastomeric material may be made from a material, e.g. TPE, having a Shore D hardness from about 20 to about 60, or a Shore D hardness of about 40. A Shore D hardness of about 40 corresponds to a Shore A hardness of about 90. If thermoplastic materials, e.g. polypropylene (PP), are used, the Shore D hardness may be from about 40 to about 60. An elastomeric pad made from a material having a Shore D hardness from about 20 to about 60 possesses a moderate level of hardness. This range strikes a balance between softness and rigidity, providing the elastomeric pad with desirable properties for its intended use. It offers sufficient flexibility, durability, and resilience and can conform to the shape and contours of different personal care items while maintaining its shape and providing a secure attachment.

The elastomeric pad may be unitarily formed as one piece. In other words, the entire pad can be created and provided as a single, integrated component without any separate or detachable parts. Creating the elastomeric pad as one piece can simplify the manufacturing process. It eliminates the need for assembling or joining different parts, streamlining production and reducing assembly costs. The unitary formation allows for efficient and consistent manufacturing. Also, the unitary formation contributes to the ease of use of the anti-theft device. There are no separate components or parts that need to be managed or assembled by the user. The pad can be readily attached to the personal care item without any additional steps or complexity, providing convenience and user-friendly operation. By being unitarily formed as one piece, the elastomeric pad offers structural integrity, simplified manufacturing, enhanced durability, ease of use, and consistent attachment properties.

The elastomeric pad may comprise a notch, and the first end of the security cord may be insertable into the notch. Such notch represents a cut-out within the pad, and allows for insertion of the first end of the security cord from the front to the back side of the elastomeric pad. To ensure a secure connection between the security cord and elastomeric pad, the first end of the security cord may comprise a hook which can engage with a bulge provided on the back side of the elastomeric pad.

To enable easy insertion of the hook and clamping of the cord when inserted, the notch provided in the elastomeric pad may be a T-shaped notch having a horizontal portion and a vertical stem. The T-shape offers a clear and defined guide for the insertion of the hook of the security cord. While the horizontal portion of the cut-out of the T-notch aligns with the direction of the cord/hook insertion, the vertical stem of the T-notch provides a guide for the hook to slide into place. This ensures proper alignment and orientation of the cord within the notch. As the cord is pushed into the notch, the vertical stem acts as a clamping surface, applying pressure on the cord from both sides and preventing it from easily sliding out. This may create an even more secure and reliable connection between the cord and the elastomeric pad.

The T-shaped notch may comprise at least one protrusion, or two protrusions. These protrusions may be arranged in an alternating manner. Such protrusion(s) may be arranged in the region of the vertical stem of the T-shaped notch. The protrusions within the T-shaped notch may provide increased grip and friction to the security cord when inserted. These protrusions create additional contact points between the cord and the elastomeric pad, increasing the frictional force. When the cord gets inserted into the vertical stem of the notch and gets pushed up, the protrusions engage with the cord, thereby creating a locking effect. In other words, the protrusions help to maintain the position and alignment of the cord within the pad, which reduces the risk of lateral movement or dislodgment, and ensures a more secure and reliable attachment. When the cord is located/locked in the vertical stem of the T-shaped notch, the hook provided at the first end of the cord can be flipped over to engage with the bulge to firmly affix the first end of the cord to the back side of the pad.

The following is a non-limiting discussion of an example embodiment of a kit comprising a personal care item and an anti-theft device in accordance with the present disclosure, where reference to the Figures is made.

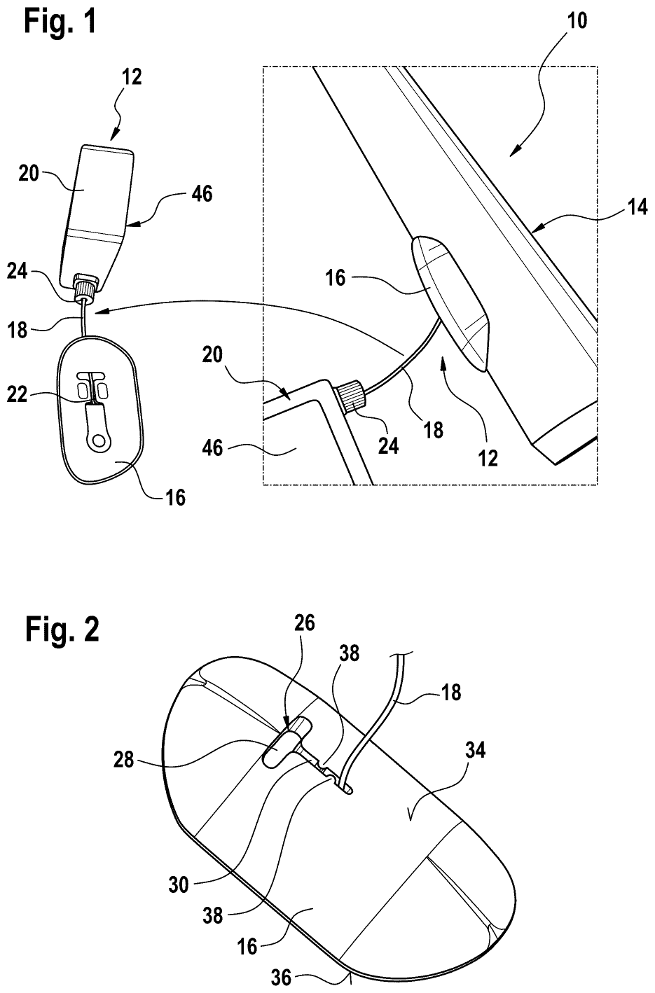

FIG. 1 shows a kit 10 comprising an anti-theft device 12 and a personal care item 14, in the present case a handle of an electrical toothbrush 12. The anti-theft device 12 incorporates an elastomeric pad 16, a security cord 18 and a mounting tool 20. A first end 22 of the security cord 18 is attached to the elastomeric pad 16, while a second end 24 of the security cord 18 is attached to the mounting tool 20. The security cord 18 can be made from stainless steel and/or aramid fiber, for example.

The elastomeric pad 16 may be made from thermoplastic elastomeric material, from silicone rubber or natural rubber. The elastomeric pad 16 may be unitarily formed as one piece. The material from which the pad 16 is made may have a Shore D hardness from about 20 to about 60, preferably 40, allowing for elasticity and flexibility to adapt to the contour of different types of personal care items, while providing sufficient stability and resilience.

As shown in FIGS. 2, 3 and 4, the elastomeric pad 16 comprises a notch 26 through which the first end 22 of the security cord 18 is insertable. As illustrated in FIG. 4, the first end 22 of the security cord 18 comprises a hook 32 which is insertable into the notch from a front side 34 to the back side 26 of the elastomeric pad 16. Said hook 32 engages with a bulge 40 provided on the back side 36 of the elastomeric pad 16, thereby providing a secure connection between the security cord 18 and the elastomeric pad 16.

The notch 26 has the form of a “T” comprising a horizonal portion 28 and vertical stem 30. The hook 32 provided at the first end 22 of the security cord 18 is insertable through the horizontal portion 28 of the T-shaped notch 26. When inserted, the security cord 18 can be pushed up along the vertical stem 30, thereby clamping the cord 18 and holding it in place. The hook 32 can then be flipped on the back side 36 of the elastomeric pad 16 to engage with the bulge 40. Once the hook 32 is snapped over the bulge 40, secure locking is provided.

The T-shaped notch 26 may further comprise two protrusions 38 which are arranged in an alternating manner along the vertical stem 30. Such protrusions 38 have a further locking effect preventing the security cord 18 from sliding back to the horizontal portion 18 of the T-shaped notch 26.

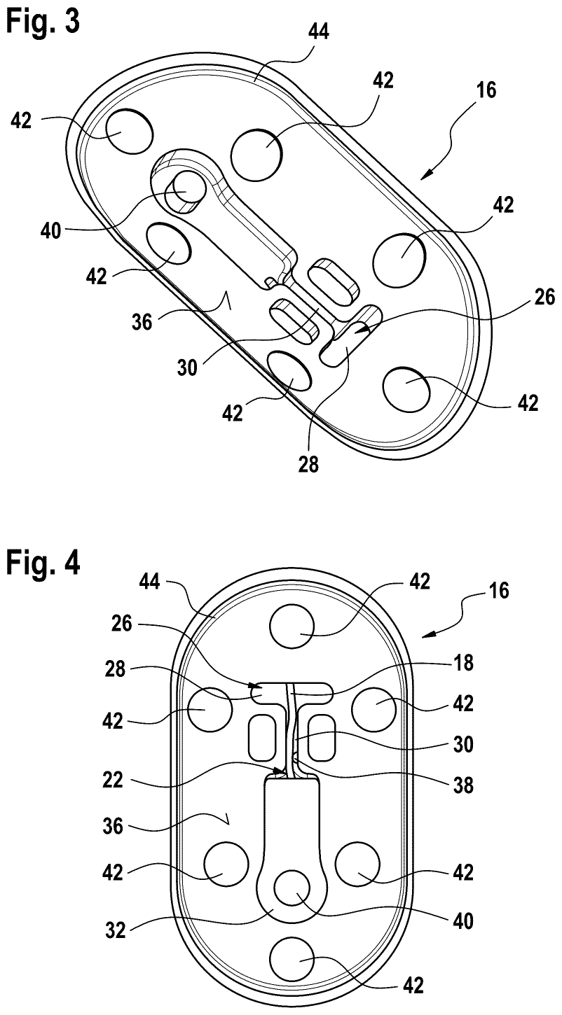

As shown in FIGS. 3 and 4, the elastomeric pad 16 may be provided with gluing spots 42 on its back side 36 for gluing the elastomeric pad 16 to the personal care item 14. Such spots 42 represent designated areas for applying adhesives/glue. An outer rim 44 may be further provided on the back side 36 of the elastomeric pad 16 to ensure retention of the adhesive material or glue, and to prevent spreading or overflow.

The elastomeric pad allows the anti-theft device 12 to be securely attached to a large variety of different personal care items 14, thereby preventing theft in a store or unauthorized removal.

The mounting tool 20 of the anti-theft device 12 may be made from plastic or other suitable materials, like stainless steel or metal. The mounting tool 20 may have the form of a small box being able to house the security cord 18 as well as a retraction mechanism allowing the security cord 18 to be extended and automatically retracted when released. When the personal care item 14 is displayed in a store, the security cord 18 can be extended, allowing the item 14 to be used or examined by potential customers, while preventing theft or unauthorized removal.

The mounting tool 20 may further comprises an adhesive tape 46 at one side of the tool 20 for securely fixing the mounting tool 20 to a wall or other fixed objects.

The combination of the elastomeric pad 16 according to the present disclosure, the security cord 18, and mounting tool 20 creates a comprehensive anti-theft system 12. The elastomeric pad 16 can be securely attached to the personal care item 14, while the security cord 18 connects the pad 16 to the mounting tool 20. By affixing the mounting tool 20 to a fixed object, the anti-theft device 12 effectively prevents the personal care item 14 from being stolen or removed without permission.

The described anti-theft device 12 offers ease of attachment, compatibility with various personal care items 14, and secure retention of the item 14 within a store environment. It provides retailers with an effective means of protecting valuable personal care items 14, while allowing customers to interact with the item 14.

In the context of this disclosure, the term “substantially” refers to an arrangement of elements or features that, while in theory would be expected to exhibit exact correspondence or behavior, may, in practice embody something slightly less than exact. As such, the term denotes the degree by which a quantitative value, measurement or other related representation may vary from a stated reference without resulting in a change in the basic function of the subject matter at issue.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

What is claimed is:

1. An anti-theft device (12) for a personal care item (14), the anti-theft device (12) comprising an elastomeric pad (16) attachable to the personal care item (14), a security cord (18) and a mounting tool (20) for mounting the anti-theft device (12) to a wall or other fixed object, the security cord (18) having a first end (22) and a second end (24), the first end (22) being attachable to the elastomeric pad (16), and the second end (24) being attached to the mounting tool (20).

2. The anti-theft device (12) according to claim 1, wherein the elastomeric pad (16) is made from a thermoplastic elastomeric material, from thermoplastic material, e.g. polypropylene (PP), from silicone rubber or natural rubber.

3. The anti-theft device (12) according to claim 2, wherein the elastomeric pad (16) is made from a material having a Shore D hardness from about 20 to about 60, preferably about 40.

4. The anti-theft device (12) according to claim 1, wherein the elastomeric pad (16) is unitarily formed as one piece.

5. The anti-theft device (12) according to claim 1, wherein the elastomeric pad (16) comprises a notch (26), the first end (22) of the security cord (18) being insertable into the notch (26), thereby providing a secure connection between the security cord (18) and elastomeric pad (16).

6. The anti-theft device (12) according to claim 5, wherein the notch (26) is a T-shaped notch (26).

7. The anti-theft device (12) according to claim 5, wherein the first end (22) of the security cord (18) comprises a hook (32) insertable into the notch (26) from a front side (34) of the elastomeric pad (16) to a back side (36) of the elastomeric pad (16).

8. The anti-theft device (12) according to claim 6, wherein the T-shaped notch (26) comprises at least one protrusion (38), preferably two protrusions (38), further preferably the protrusions (38) being arranged in an alternating manner.

9. The anti-theft device (12) according to claim 7, wherein the elastomeric pad (16) comprises a bulge (40) on the back side (36) of the elastomeric pad (16), the hook (32) of the security cord (18) engaging with the bulge (40) when the hook (32) is inserted into the notch (26).

10. The anti-theft device (12) according to claim 1, wherein the back side (36) of the elastomeric pad (16) comprises gluing spots (42) for gluing the elastomeric pad (16) onto a surface of the personal care item (14).

11. The anti-theft device (12) according to claim 1, wherein the back side (36) of the elastomeric pad (16) comprises an outer rim (44) for retaining glue at the back side (36) of the elastomeric pad (16).

12. The anti-theft device (12) according to claim 1, wherein the mounting tool (20) comprises an adhesive tape (46) for gluing the mounting tool (20) to a wall or other fixed object.

13. The anti-theft device (12) according to claim 1, wherein the mounting tool (20) comprises a retraction mechanism allowing the security cord (18) to be extended and automatically retracted when released.

14. The anti-theft device (12) according to claim 1, wherein the security cord (18) is made from stainless steel and/or aramid fiber.

15. A kit (10) comprising an anti-theft device (12) according to claim 1 and a personal care item (14).
